(19) United States
(12) Patent Application Publication
(10) Pub. No.: US 2009/0166558 A1
(43) Pub. Date: Jul. 2, 2009

(54) Phase Contrast Electron Microscope Device

(76) Inventor: Kuniaki Nagayama, Aichi (JP)

Correspondence Address: WENDEROTH, LIND & PONACK, L.L.P., 1030 15th Street, N.W.,, Suite 400 East, Washington, DC, 20005-1503, US

(21) Appl. No.: 12/084,955

(22) PCT Filed: Nov. 14, 2006
(86) PCT No.: PCT/JP2006/322680

§ 371 Date: May 14, 2008

(30) Foreign Application Priority Data
Nov. 15, 2005 (JP) 2005-330374

(51) Int. Cl. G21K 5/10; G01N 23/00

(52) U.S. Cl. 250/442.11; 250/311

(57) ABSTRACT

A confocal method in which a sample is disposed in the center, a collective lens and a front objective lens are disposed on the incident side, and a back objective lens and a projection lens are disposed symmetrically on the outgoing side is so configured that a spatial filter can be inserted in front of the sample and behind it. As a result, the advantage of the confocal method, which is in the possibility of disposing a spatial filter in front of the sample, is realized and the disadvantages of the conventional transmission phase contrast electron microscope (halo, electron beam loss) are eliminated, thereby providing a phase contrast electron microscope device that enables the establishment of an electron microscopy technology that makes it possible to view of a wide range of materials from material science to life science in a non-dyed state with a high contrast and a high resolution.

### TECHNICAL FIELD

The present invention relates to a phase contrast electron microscope device.

### BACKGROUND ART

An electron microscope, which is by its nature a paraxial optical system with a large focal depth, is not incompatible with a confocal method aimed at the decrease in focal depth. For this reason, the confocal microscope of Zaluzec (see U.S. Pat. No. 6,548,810 B2, “Scanning Confocal Electron Microscope”, S. P. Frigo, Z. H. Levine and N. J. Zaluzec, “Submicron Imaging of Buried Integrated Circuit Structures Using Scanning Confocal Electron Microscope”, Appl. Phys. Lett. 81 (2002) 2112-2114) is not applied to regions requiring high resolution, but only to thick materials that cannot be handled by the usual electron microscopes.

On the other hand, in the conventional phase contrast electron microscopes (Japanese Patent Applications Laid-open Nos. 2001-273866, 2002-237272, and 2003-100249 and Japanese Patent Applications Nos. 2004-351902 and 2005-321402), because a phase plate is introduced behind a sample, the trajectory of electron beam carrying the image information is disturbed and image distortions caused by electric charging or signal intensity decrease caused by electron beam loss are induced. Among these problems, the distortion of image caused by electric charging has been resolved (Japanese Application No. 2004-351902), but the decrease in signal intensity caused by electron beam is difficult to prevent.

The electron beam loss decreases signal intensity over the entire frequency range. At the low-frequency side, the increase in contrast can be realized because the decrease is compensated by the properties of phase contrast method, but the decrease in signal intensity at the high-frequency side is not compensated and leads to the decrease in resolution.

### DISCLOSURE OF THE INVENTION

### Problems To Be Solved by the Invention

With the foregoing in view, it is an object of the present invention to provide an electron microscope device of a new phase contrast type that, by contrast with the above-described prior art, employs the merits of the confocal method, that is, the possibility of disposing a spatial filter such as an aperture or a phase plate in front of the sample, and eliminate the drawbacks of the conventional transmission phase contrast electron microscopes.

### Means for Solving the Invention

In order to solve the above-described problems, the present invention provides, firstly, an electron microscope having a confocal configuration in which a collective lens and a front objective lens on the incident side and a back objective lens and a projection lens on the outgoing side are disposed symmetrically with respect to a sample as a center, the electron microscope being configured as a lens system in which a light (hereafter light means electron optical light) source image is formed on the sample and an image observation surface, wherein a spatial filter such as an aperture or a phase plate that can be introduced and removed is inserted in the collective lens on the incident side, and a spatial filter that can be introduced and removed is inserted in the projection lens on the outgoing side.

Secondly, the electron microscope of a sample scanning type in which the light source is a point light source, a detector is a point detector, and the sample itself is scanned.

Thirdly, the electron microscope of a light flux scanning type in which the light source is a point source, a detector is a point detector, the sample is fixed, a deflecting plate is introduced in the vicinity of a back focal point of the collective lens and in the vicinity of a front focal point of the objective lens respectively, and a conjugate scanning is performed.

Fourthly, the electron microscope of a non-scanning type in which the light source is a non-interferential plane light source, a detector is a point decomposition plane detector such as a CCD camera, and the sample is fixed and observed.

Fifthly, the electron microscope which employs a confocal method in which a semicircular π phase plate or a knife edge is inserted as the spatial filter in the collective lens on the incident side, and an aperture is inserted as the spatial filter in the projection lens of the outgoing side.

Sixthly, the electron microscope which employs a confocal method in which an aperture is inserted as the spatial filter in the collective lens on the incident side, and a semicircular π phase plate or a knife edge is inserted as the spatial filter in the projection lens of the outgoing side.

Seventhly, the electron microscope which employs a confocal method in which a semicircular π phase plate or a knife edge is inserted as the spatial filter in both the collective lens on the incident side and the projection lens of the outgoing side.

Eighthly, the electron microscope wherein a front magnetic field of the objective lens forms the front objective lens.

Ninthly, the electron microscope wherein a back magnetic field of the objective lens forms the back objective lens.

Tenthly, the electron microscope having a plurality of collective lenses into which the spatial filter can be inserted.

Eleventhly, the electron microscope having a plurality of projection lenses into which the spatial filter can be inserted.

Twelfthly, the electron microscope wherein an energy filter is inserted behind the projection lens.

Thirteenthly, the electron microscope wherein a tilting stage having a tilting function is inserted as a sample stage and tomographic image reconstruction is enabled.

Fourteenthly, the electron microscope wherein a tilting sample stage that that can be temperature controlled to a high temperature is inserted as a sample stage.

Fifteenthly, the electron microscope wherein a tilting sample stage that is cooled with liquid nitrogen is inserted as a sample stage.

Sixteenthly, the electron microscope wherein a tilting sample stage that is cooled with liquid helium is inserted as a sample stage.

Seventeenthly, the electron microscope wherein a stage for performing a mechanical elongation test of the sample is inserted.

Eighteenthly, the electron microscope wherein a plane light source in which two collective lenses are combined with a diffusive scattering plate inserted between the lenses is used as a non-interferential light source of an electron beam.

Nineteenthly, the electron microscope wherein a thin film of a noble metal is used as the diffusive scattering plate.

Twenteethly, the electron microscope wherein a very small central light shielding plate is inserted as the spatial filter on the incident side and a background inelastic scattering generated from the noble metal diffusion plate is caused to extinct.

Twenty-firstly, the electron microscope wherein photoelectrons from a photoelectric plate irradiated with a laser beam are used as a non-interferential light source of an electron beam.

Twenty-secondly, the electron microscope wherein a collective minilens is disposed, switching can be performed between a confocal mode and a parallel illumination mode, and a confocal electron microscope and a transmission electron microscope can be used together.

Twenty-thirdly, the electron microscope wherein a filter stage for a phase plate that can be introduced into the collective lens and removed therefrom is mounted for a confocal mode, and a filter stage for phase plate that can be introduced and removed in a back focal plane of the objective lens system is mounted for a parallel illumination mode.

Twenty-fourthly, the electron microscope wherein the value relationship of a cut-off frequency of the phase plate and a cut-off frequency of the aperture can be freely set to optimize a combined spatial filter composed of the phase plate on the incident side and the aperture on the outgoing side.

Twenty-fifthly, the electron microscope wherein the value relationship of a cut-off frequency of the phase plate and a cut-off frequency of the aperture can be freely set to optimize a combined spatial filter composed of the aperture on the incident side and the phase plate on the outgoing side.

Twenty-sixthly, the electron microscope wherein the value relationship of cut-off frequencies of the two phase plates can be freely set to optimize a combined spatial filter composed of the phase plate on the incident side and the phase plate on the outgoing side.

In accordance with the present invention that has the above-described features, it is possible to realize not only a conventional phase contrast electron microscope in which a phase plate is disposed behind the sample (on the projection lens side), but also a phase contrast electron microscope in which a phase plate is disposed in front of the sample (on the collective lens side). As a result, composition spatial filters of various types that have heretofore been unknown can be designed and an electron microscope technology that can resolved both the problem of the phase plate being electrically charged and the problem of electron beam loss can be established.

Presently, there are three types of electron microscopes: a transmission type (TEM: Transmission Electron Microscope), a scanning type (SEM: Scanning Electron Microscope), and a scanning transmission type (STEM: Scanning Transmission Electron Microscope), and each type has its own drawbacks and advantages. On the other hand, there are also optical microscopes of equivalent types, and the performance thereof has been dramatically improved in recent years by the introduction of the confocal method. However, in the field of electron microscopes, the advantages of the confocal method could not be employed because of a paraxial optical system having a large focal depth.

Accordingly, the inventors of the present invention have conducted faithful research and development, and the results obtained clearly demonstrated that significant advantages are obtained when a confocal method is applied to a phase contrast method and led to the conception of the present invention.

Main features of the present invention are described below.

1. The resolution of the conventional method is almost doubled.

2. In the case of the phase contrast method, the phase plate can be disposed in front of the sample. Therefore, electron beam loss can be avoided and contrast can be increased without decreasing the resolution.

3. Where a semicircular π phase plate or a knife edge is used, the phase differential contrast image does not depend on the sample thickness and the application range of the phase contrast method can be expanded. A Foucault differential contrast method (K. Nagamaya, J. Phys. Soc. Jpn. 73 (2004) 2725) that has been ineffective in the transmission-type phase contrast method is effectively implemented.

4. Where a semicircular π phase plate is used, the phase differential contrast image of the dark view field does not depend on the sample thickness and the application range of the phase contrast method can be expanded.

5. A halo on the image circumference that is a crucial drawback of the phase contrast method, is eliminated.

6. In the confocal method of a non-scanning type, the entire view field can be recorded at once, without scanning, and the image recording time can be dramatically shortened with respect to that of the conventional STEM.

7. Where a combination with an energy filter is employed, samples can be handled that have a thickness 100 times that at which an inelastic scattering absorption image can be observed in the usual samples for electron microscopy.

8. Image distortions resulting from defocusing are small. Therefore, image quality in the depth direction is improved over that attained when TEM or STEM is used in tomographic observations that require tilted samples.

### BRIEF DESCRIPTION OF THE DRAWINGS

FIGS. 1(a), (b), (c) are schematic drawings illustrating examples of the conventional electron microscope devices.

FIG. 2 is a drawing for explaining the confocal method suggested by M. Minsky.

FIGS. 3(a), (b), (c) are schematic drawings illustrating examples of electron microscope devices of a sample scanning type, light flux scanning type, and non-scanning type of the present invention.

FIG. 4 is a schematic drawing illustrating an example of an electron microscope device of an equivalent transmission type of the present invention.

FIG. 5 is a schematic drawing illustrating an example of an electron microscope device of an equivalent confocal type of the present invention.

FIGS. 6(a), (b) are drawings for explaining a light conversion function in the electron microscope devices shown in FIG. 4.

FIGS. 7(a), (b) are drawings for explaining a light conversion process in the electron microscope devices shown in FIG. 5.

FIGS. 8(a), (b) are schematic drawings illustrating examples of the conventional electron microscope devices of an equivalent transmission phase contrast type and equivalent confocal phase contrast type.

FIG. 9 is a schematic drawing illustrating an example of an embodiment of the phase plate.

FIG. 10 is a schematic drawing illustrating an example of an embodiment of the phase plate.

FIG. 11 is a schematic drawing illustrating an example of an embodiment of the phase plate.

FIG. 12 is a schematic drawing illustrating an example of an embodiment of the phase plate.

FIG. 13 is a drawing for explaining point images obtained with various spatial filters.

FIG. 14 is a schematic drawing illustrating the effect obtained in the case where a cut-off frequency on the incidence light side is higher than the cut-off frequency on the outgoing side in the confocal method using a semicircular π filter.

FIG. 15 is a drawing illustrating a metal cluster and a one-dimensional chain of a metal cluster used in electron microscope simulation.

FIG. 16 is a drawing illustrating the performance comparison of the transmission method—phase contrast method and confocal method—phase contrast method based on the simulation image of the one-dimensional chain of a metal cluster.

FIG. 17 is a drawing illustrating the performance comparison of the transmission phase contrast method and confocal phase contrast method based on the simulation image of the one-dimensional chain of a metal cluster.

FIG. 18 is a drawing illustrating the performance comparison of the transmission phase contrast method and confocal phase contrast method based on the simulation image of the one-dimensional chain of a metal cluster.

FIGS. 19(a), (b) are schematic drawings illustrating an electron microscope device of a type with switching between a confocal mode and a parallel illumination mode of the present invention.

### BEST MODE FOR CARRYING OUT THE INVENTION

i) Conventional Electron Microscope

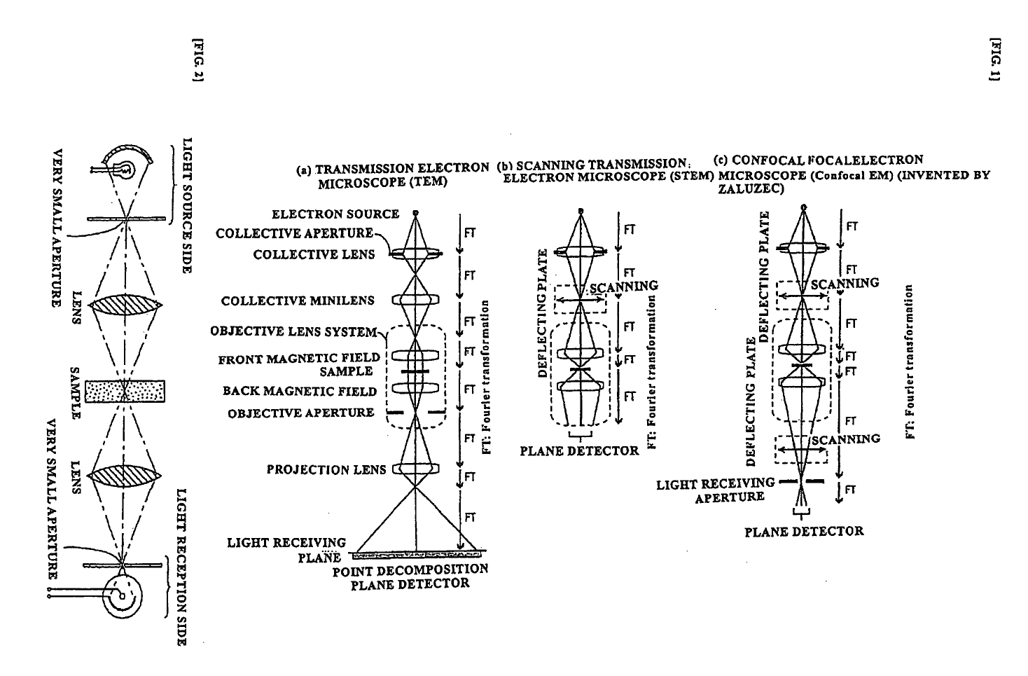

First, a conventional electron microscope will be explained using FIGS. 1(a), (b), (c). In FIGS. 1(b), (c), no reference symbols are assigned to the structural elements identical to those of FIG. 1(a).

In a TEM, as shown by way of example in FIG. 1(a), a point light source (point electron source) is converted into a parallel beam (parallel electron wave) by a lens system to irradiate a sample, and the light (electron wave) that has been transmitted through the sample is expanded by a lens system, and caused to fall on a light receiving plate of a point decomposition plane detector such as a photographic detector or a CCD (Charge Coupled Device) camera to produce an image. A parallel light containing scattered electrons from the sample is once collected at an aperture stop and then the so-called image is produced on the entire light receiving plane by a projection lens. Therefore, the image pickup is performed by opening a shutter, as it is called in cameras, for example, for 0.1 sec.

On the other hand, in a STEM, as shown by way of example in FIG. 1(b), an image of a point light source is collected as points on a sample, and the entire scattered light therefrom, or part thereof, is obtained in a plane detector. The plane detector is typically disposed close to the optical axis anywhere behind the sample. In the case of STEM, only a very small portion on the sample can be detected in one detection cycle. Therefore, an electron beam has to be scanned over the sample. In an electron microscope, such scanning is performed using deflecting plates, but such scanning is identical to the electron beam scanning in a Broun tube television and the merit thereof is that it can be performed at a high speed. In the STEM, the electron beam scanning is usually performed only on the incident side and is not performed on the outgoing side. Such being the case, the deflection of optical axis on the light receiving plane that accompanies the scanning of the incident electron beam is canceled by enlarging the detection plane of the plane detector. However, a shortcoming in this case is that detection sensitivity decreases when the optical axis is strongly deflected.

The advantage of the confocal electron microscope of Zaluzec that is shown by way of example in FIG. 1(c) is that this drawback is overcome, electron beam scanning is performed on both the incident side and the outgoing side, and the deflection of the incident electron beam is conjugatively canceled on the outgoing side. Further, two technological requirements of the confocal microscopes that are described below have been provided.

ii) Technological Requirements of Conventional Confocal Electron Microscopes

Prior to explaining the gist of the present invention, the essence of the confocal method that has been successfully employed in optical microscopes will be discussed in general terms.

The confocal method was invented by M. Minsky in 1957 (UP Patent 3013467, “Microscopy apparatus”). The trial manufacture was performed by Minsky himself, and the complete actual verification was performed by Egger et al. in the second half of 1960s (Science 1157 (1967) 305, Nature 223 (1969) 831).

There are two technologically novel main ideas in the original confocal method.

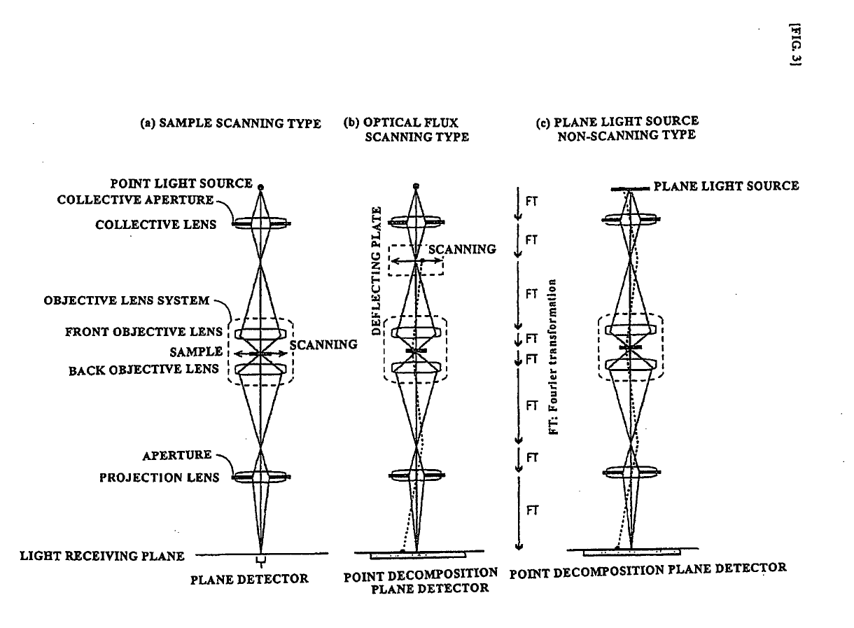

The first, as shown by way of example in FIG. 2, is in a structure in which focal points of two lenses of the same performance that are introduced symmetrically on both sides of a sample overlap on the sample surface, this structure giving the name to the method. In this aspect, the two electron microscopes shown in FIGS. 1(b), (c) satisfy the confocal requirement.

However, the original confocal method has yet another requirement shown in FIG. 2. This requirement relates to ensuring the symmetry of light source and light reception, in particular the possibility of point light source and point detection. In FIG. 2, this is ensured by a very small aperture on the light source side and a very small aperture on the light reception side, the apertures being introduced symmetrically. In the confocal electron microscope invented by Zaluzec, the light receiving aperture shown in FIG. 1(c) is located at the focal plane on the light outgoing side and a confocal microscope is configured.

The idea of Minsky who invented the confocal microscope was that the unnecessary scattered light is cut off by using the very small aperture, and optical information is taken out on only a portion in the sample where the point light source image is converged at the focal point. Namely, the idea was to decrease the focal depth and increase the positional selectivity in the depth direction. In this sense, the light receiving aperture is essential, and this aperture completely cuts off the light that comes from the outside of the focal point in the sample. As a result, three-dimensional point-selective observations with a very small background noise could be realized.

Another advantage is in that the resolution is almost doubled. An article describing a confocal optical microscope, in the strict sense of the expression, in which this advantage was proved based on the wave optics theory was published in 1970s (C. J. R. Sheppard and A. Choudhury, Optica Acta 24 (1977) 1051-1073).

iii) Confocal Electron Microscope Design of the Present Invention

A definite difference between an optical microscope and an electron microscope is in the focal depth. An electron microscope is a paraxial optical system having a very small numerical aperture of 0.01 or less, and the specific feature thereof is that the so-called focusing is performed within a range that is 100 or more times larger than the effective resolution. Thus, position selection in the depth direction cannot be performed by changing the focus as experienced in an optical microscope. This feature has been widely recognized and a combination of the confocal method and electron microscopy has not been realized for a long time because it could not employ the particular features of the confocal method.

The confocal electron microscope of Zaluzec was invented without any relation to such apprehension of the electron microscopy community, and the confocal electron microscope has no advantages over the usual electron microscopes in high-resolution applications inherent to electron microscopy. In this respect, conversely, the confocal electron microscope is effective with respect to thick samples that cannot be handled by the usual TEM, STEM due to the blurring of the entire image caused by multiple scattering, and the confocal electron microscope makes it possible to obtain an image even in thick samples, albeit with a low resolution, because the multiple electron scattering is cut off with a light receiving aperture. However, where a TEM or STEM equipped with an energy filter is used with respect to thick samples, the effect obtained is similar to that obtained in the confocal electron microscope invented by Zaluzec (multiple scattered electrons are cut off with the energy filter instead of the light receiving aperture) and, therefore, the confocal electron microscope demonstrates no special merits and has found practically no application.

The present invention has been accomplished with the foregoing in view.

FIGS. 3(a)(b)(c) illustrate confocal methods of three kinds in the present invention.

Following the basic configuration of the Zaluzec confocal method, a projection lens was introduced at the outgoing side and an insertion portion for a spatial filter was ensured. Representing it with Fourier transform (FT), which is a term of wave optics, in the case of STEM (FIG. 1(b)), a signal is detected after one FT behind the sample plane, in the confocal electron microscope of Zaluzec (FIG. 1(c)), a signal is detected after three FT, and in the present invention (FIG. 3), a signal is detected after four FT. In another representation, in accordance with the present invention, a point light source image is created on a sample plane and this image is also crated on a light receiving plane. Further, the incident side and outgoing side maintain a symmetry with respect to the sample plane from the light source to light reception. Because the point of the point light source is a also a point on the light receiving plane, the detection is essentially a point detection, this being different from the plane detection of STEM.

Taking into account a distinctive feature of the point of the point light source corresponding to a point on the light receiving plane, three systems can be considered. Namely, a sample scanning type (FIG. 3(a)) using a point detector, a light flux scanning type (FIG. 3(b)) using a point decomposition plane detection such as in photography or CCD, and a non-scanning type (FIG. 3(c)) in which a point light source is replaced with a non-interferential plane light source, scanning is stopped, and an image is formed over the entire light receiving plane.

In the present invention, a light receiving aperture located immediately before the light receiving plane, which is essential for the confocal method, is absent. There is no need in it. This is because the so-called focusing is performed in all the positions in the depth direction even in a thick sample (large focal depth) due to a large focal depth feature of electron microscopes, and therefore optical information from locations with different depth does not spread as a background noise over the light receiving plane. A configuration employing this advantage is of a light flux scanning type using a point decomposition plane detector such as CCD of FIG. 3(b). Because focusing is performed on different locations on a light receiving plane corresponding to the light flux scanning on the incident side, a point decomposition plane detector, which is a two-dimensional array of a large number of point detectors, can directly reproduce an image. In this case, by contrast with the confocal method of Zaluzec, the conjugated light flux scanning on the outgoing side becomes unnecessary.

With the phase contrast method of the present invention, image distortion caused by defocusing can be decreased. Therefore, the advantage obtained in applications to tomographic observations that require a tilting sample is that image quality in the depth direction is improved. In this case, tomographic image reconstruction is possible where a tilting stage having a tilting function is inserted as a sample stage. A temperature-controllable tilting stage can be inserted as a sample stage according to the type of application. A high-temperature tilting stage, a tilting sample stage cooled with liquid nitrogen, or a tilting sample stage cooled with liquid helium can be used as such temperature-controllable tilting sample stage.

Further, in accordance with the present invention, a stage for performing a mechanical elongation test of the sample can be also inserted.

As one more improvement, it is clear that light scanning is also not employed. Where the light source is a plane light source, each point of the plane light source is one-to-one linked to a focal point on the plane detector. Therefore, as shown in FIG. 3(c), scanning is unnecessary. However, it is necessary that the adjacent portion of the plane light source serve as independent light sources, that is, incoherent. This is necessary to prevent the images of adjacent points on the light receiving plane from interfering with each other. In order to produce such a incoherent plane light source, it is possible: i) to insert an electron beam diffusive scattering plane in which a thin film (thickness of 100 nm or less) of a noble metal sandwiched between two lenses between a point light source and a front lens and use diffusive and incoherent electrons produced by multiple scattering of noble metal atoms, or ii) to irradiate a photoelectric plane with a laser beam with an adjustable light flux and use photoelectron emitted from the photoelectric plate. The surface area of the plane light source can be adjusted in both cases by adjusting the aperture hole in the former case and by adjusting the laser beam flux in the latter case.

iv) Equivalent Electron Microscope

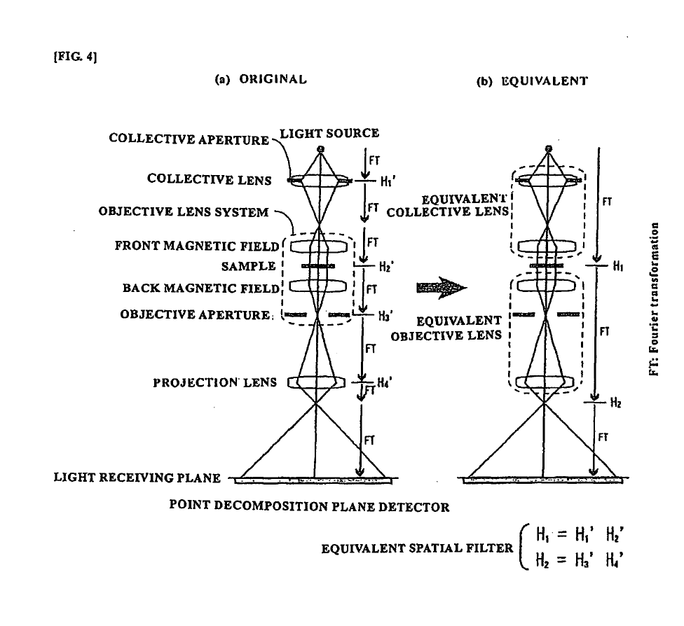

In order to expand the confocal electron microscopy to the phase contrast method, an electron microscope is converted to a simplified but optically equivalent electron microscope. FIG. 4, FIG. 5 shows equivalent electron microscopes of the TEM and confocal method.

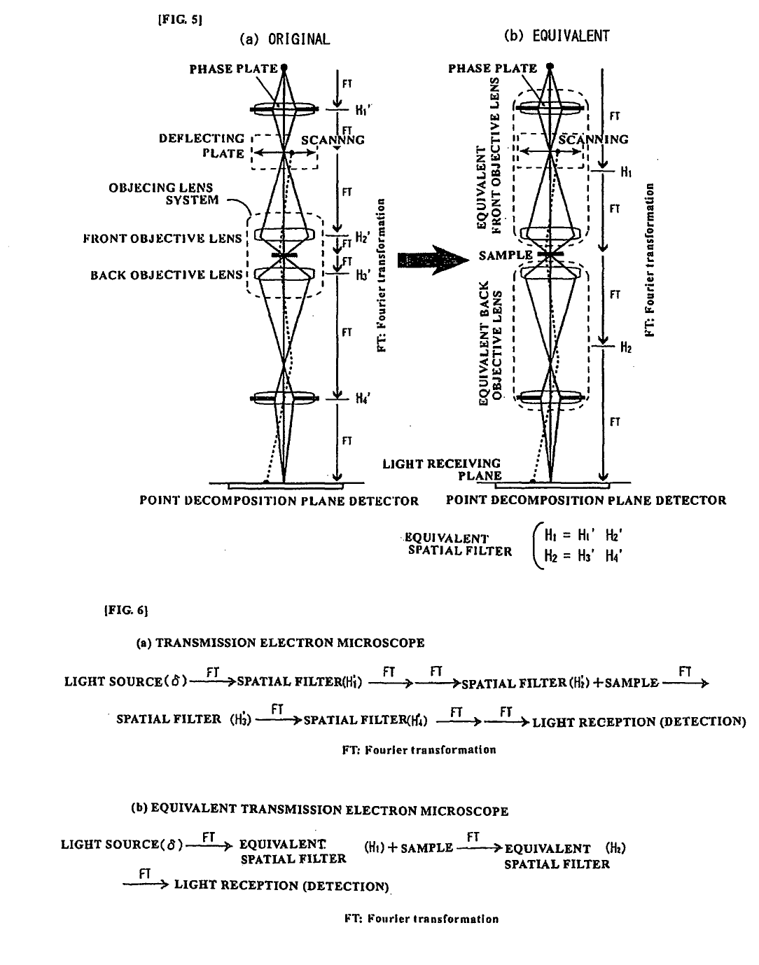

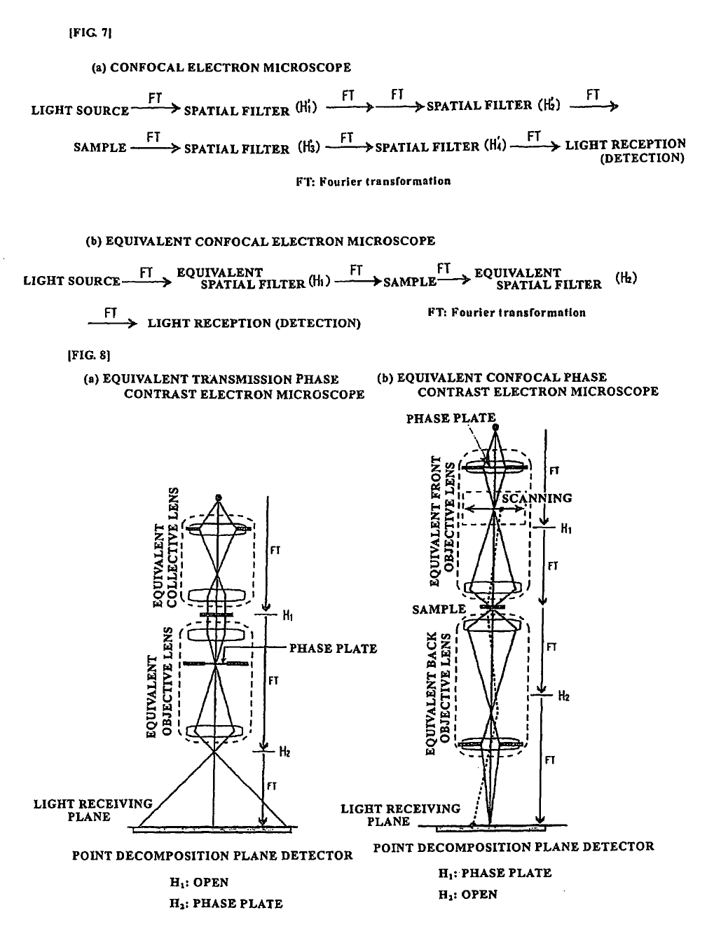

FIG. 4 relates to TEM, and an image formation process with a lens system in this configuration can be described as illustrated by FIG. 6(a). A spatial filter in FIG. 4 means any effect that acts on a spatial frequency spectrum of light such as an aperture action, a lens aberration action, or a phase plate action.

Where it is replaced with an equivalent collective lens on the incident side and an equivalent objective lens on the outgoing side, an equivalent TEM such as shown in FIG. 6(b) is obtained.

In the confocal method of the present invention that is shown in FIG. 5, the image formation process is a light conversion process shown in FIGS. 7(a)(b).

In both equivalent electron microscopes, both the equivalent space filter on the incident side and the equivalent space filter on the outgoing side are the products of elemental space filters.
Incident side: H₁=H₁′H₂′.
Outgoing side: H₂=H₃′H₄′.

The operation of the confocal electron microscope and the operation of the phase plate will be analyzed below by using the equivalent electron microscope.

V) Extension of Confocal Electron Microscopy to Phase Contrast Method

The advantages of the confocal method are best demonstrated when it is expanded to a phase contrast electron microscope. The invention relating to the phase contrast method will be described below.

A conventional transmission phase contrast electron microscope using a phase plate as a spatial filter that has been invented by the inventors of the present invention will be first explained for the purpose of performance comparison.

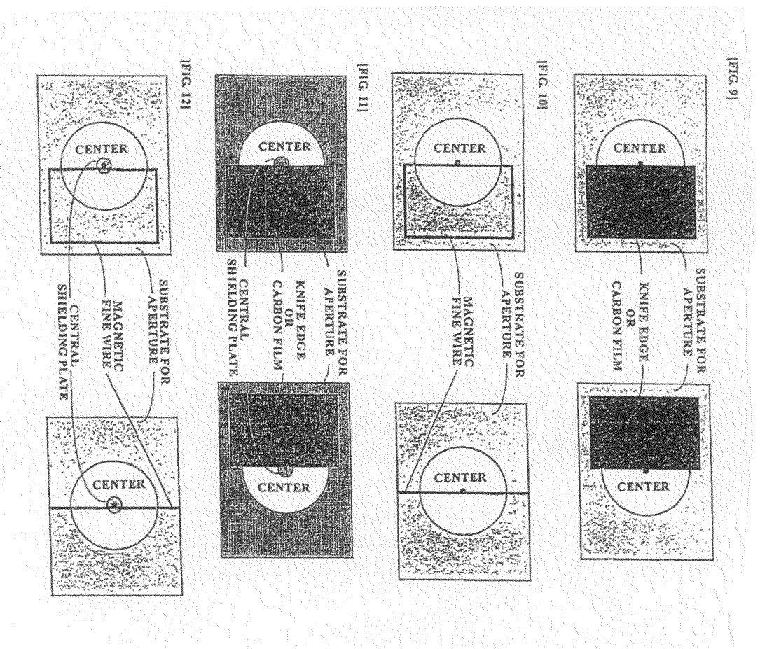

In the equivalent transmission phase contrast electron microscope shown by way of example in FIG. 8(a), a phase plate is inserted in the location of the objective aperture on the outgoing side. From the standpoint of an equivalent spatial filter, it means the insertion in H₂, and H₁ on the incident side is open. On the other hand, in the equivalent confocal phase contrast electron microscope shown by way of example in FIG. 8(b), a phase plate is introduced in the location of the collective aperture on the incident side. Thus, it is introduced in H₁, and H₂ is open.

The positions of phase plates in both cases are thus completely inverted with respect to the sample as a center. This is the essence of the present invention. Namely, in the case of the confocal method, the phase plate can be introduced in front of the sample. Therefore, the electron beam carrying optical information about the sample is completely free from the disturbance due to phase plates. As a result, it is possible to solve a variety of problems associated with the phase contrast method, such as: a) electron beam loss caused by the phase plane; b) readjustment of the phase plate position following the charging of the sample; and c) electron beam loss and strong background noise in the Foucault differential contrast method. It goes without saying, that a design in which a phase plate is inserted behind the sample, as in the phase contrast TEM method, is also possible, and such configuration can be useful, as described hereinbelow, for certain spatial filter designs.

vi) Shape of Phase Plate for Use in Confocal Electron Microscope

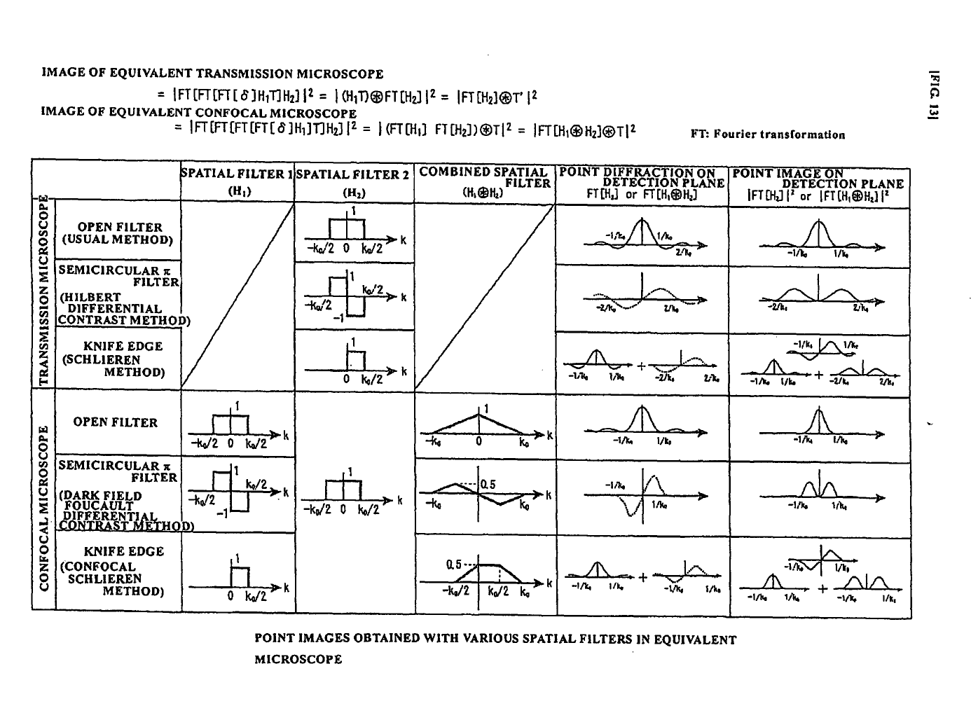

Because of using a converging beam as a sample illumination light, the confocal method differs significantly from the TEM using a parallel beam. Therefore, a zero-order beam derived from the incident beam (the origin on the objective aperture) and a high-order beam derived from the light scattered by the sample cannot be distinguished. Namely, a Zernike phase plate is not used. However, the application is possible to a semicircular carbon film spatial filter used in the Hilbert differential contrast method (see the aforementioned Japanese Patent Application Laid-open No. 2003-100249), a Foucault knife edge used in the Foucault differential contrast method (K. Nagayama, J. Phys. Soc. Jpn. 73 (2004) 2725-2731), and a loss-free phase plate (magnetic fine wire) (see the aforementioned Japanese Patent Application No. 2005-321402). The shape of these phase plates is shown in FIG. 9 to FIG. 12.

FIG. 9 shows a carbon film phase plate for the Hilbert differential contrast method and a knife edge for a bright field Foucault differential contrast method. They have a shape and insertion positions such as to cover half of the aperture in the vicinity of the collective lens or projection lens. FIG. 10 shows a magnetic fine wire for the Hilbert differential contrast method, the shape and insertion position of the magnetic fine wire being such as to span over the center of the lens aperture. The phase of the phase plate that is used is π or π/2, but in the case of a carbon film, the phase amount can be controlled by the thickness, and in the case of the magnetic fine wire, the phase amount can be controlled by the magnetic flux of the magnetic material.

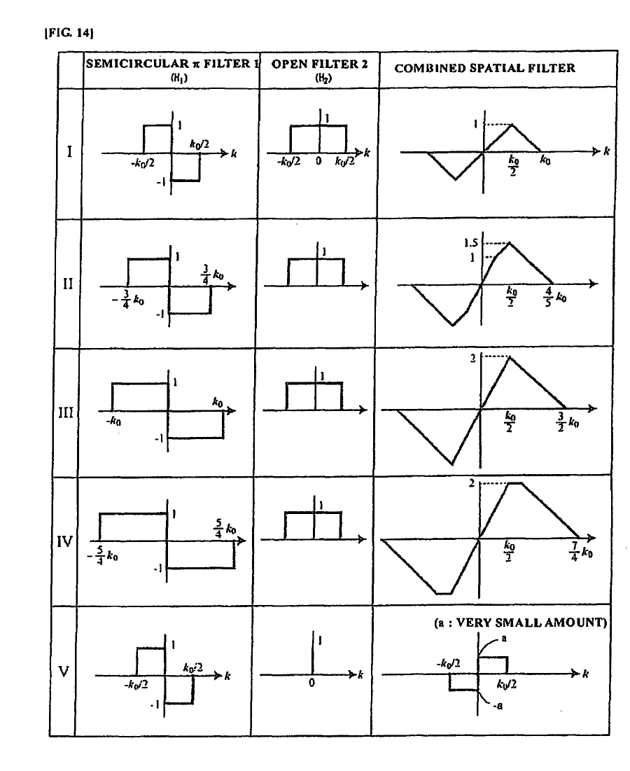

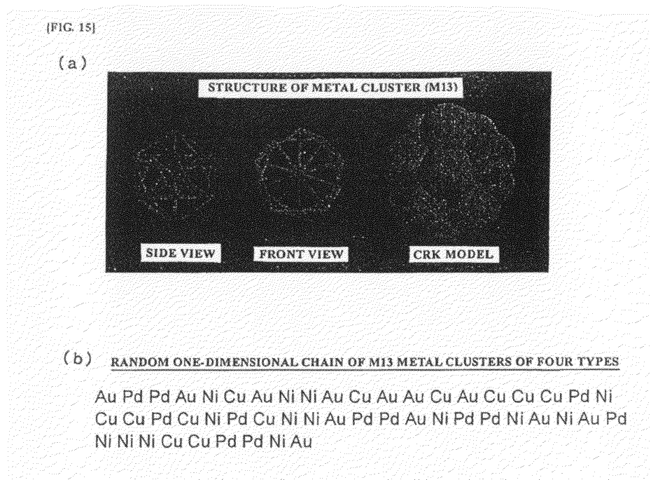

Further, FIG. 11 and FIG. 12 show configurations obtained by incorporating a central light shielding plate in the configurations shown in FIG. 9 and FIG. 10; the light shielding plate is disposed in the center of lens aperture (FIGS. 11 and 12).

The central light shielding plate is inherent to the non-scanning confocal method illustrated by FIG. 3(c) and serves to shield the inelastically scattered light from the noble metal film that appears when the diffusive scattering light is produced. It is preferred that the inelastically scattered light be cut off because it does not contribute to the image and becomes a background noise. Accordingly, the central light shielding plate is employed to cut off only the inelastic scattering, practically without cutting off any elastic scattering, by using the fact that the inelastic scattering is a forward scattering with a small scattering angle. Thus, in the phase contrast method, only the information of elastic scattering is used to form an image.

These various phase plates serving as spatial filters are inserted, for example, via a filter stage (not shown) that can be introduced in the collective lens or projection lens and removed therefrom. The lens aperture or central shielding plate also can be introduced and removed in a similar manner via a filter stage.

vii) Operation of Phase Plate

The operation of the phase plate in the confocal method will be described herein in comparison with the phase contrast TEM. A process of image formation with a microscope will be represented by Fourier transformation to understand better the operation of the filter containing the phase plate.

The equation representing the image formation process, that is, optical conversion, of a transmission electron microscope can be represented in the following manner by a few steps of Fourier transformation process with reference to the image formation process of the equivalent transmission electron microscope shown in FIG. 6(b).

$$\begin{matrix}T E M image = {\vert FT [ FT [ FT [ δ ] {H}_{1} T ] {H}_{2} ] \vert}^{2} \\ = {\vert FT [ FT [ {H}_{1} T ] {H}_{2} ] \vert}^{2} \\ = {\vert FT [ FT [ {H}_{1} T ] ⊗ FT [ {H}_{2} ] ] \vert}^{2} \\ = {\vert {H}_{1} T ⊗ FT [ {H}_{2} ] \vert}^{2} \\ = {\vert FT [ {H}_{2} ] ⊗ {T}^{′} \vert}^{2}\end{matrix} \qquad [ Formula 1 ]$$

δ=point light source represented by delta function;
H₁=spatial filter on the incident side;
T=complex transmission coefficient of the sample;
H₁T=scalar product of H₁ and T
   =represents that an incident light modified by the spatial filter H₁ illuminates the sample;
FT[ ]=Fourier transformation;
\textcircled{×}=convolution;
   | |=square of an absolute value; corresponds to detection (light reception);
T′(=H₁T) complex transmission factor of the sample including the spatial filter effect;
FT[H₂]=impulse response function of spatial filter H₂.

In Formula 1, a Fourier transform equation of FT[FT[H₁]]=H₁ (the space reversal is ignored) or FT[δ]=1 is used.

The final equation of Formula 1 shows that the image is a square of the absolute value of the convolution of the complex transmission coefficient of the sample and the Fourier transformation FT[H₂] (usually called an impulse response function) of the spatial filter H₂.

Further, the equation of the image formation process, that is, optical conversion, of the confocal electron microscope can be represented by the Fourier transformation process in the following manner with reference to the image formation process of the equivalent confocal electron microscope shown in FIG. 7(b).

$$\begin{matrix}T E M image = {\vert FT [ FT [ FT [ FT [ δ ] {H}_{1} ] T ] {H}_{2} ] \vert}^{2} \\ = {\vert FT [ FT [ FT [ {H}_{1} ] T ] {H}_{2} ] \vert}^{2} \\ = {\vert FT ( {H}_{1} ⊗ FT [ T ] ) {H}_{2} \vert}^{2} \\ = {\vert ( FT [ {H}_{1} ] T ) ⊗ FT [ {H}_{2} ] \vert}^{2} \\ = {\vert FT [ {H}_{1} ⊗ {H}_{2} ] ⊗ T \vert}^{2}\end{matrix} \qquad [ Formula 2 ]$$

δ=point light source represented by delta function;
H₁=spatial filter on the incident side;
T=complex transmission coefficient of the sample;
FT[ ]=Fourier transformation;
\textcircled{×}=convolution;
   | |=square of an absolute value; corresponds to detection (light reception);
FT[H₁\textcircled{×}H₂]=impulse response function of combined filter H₁\textcircled{×}H₂.

A mathematical trick is needed in the computation to derive the final form in Formula 2, and it was first derived in the heretofore published article (Sheppard & Choudhury).

A specific feature of the confocal method represented by the equations of Formula 2 is in that a spatial filter providing the impulse response function is represented by a convolution of H₁ and H₂ (called a combined spatial filter). The convolution does not depend on the order of H₁, H₂. Thus,

H₁\textcircled{×}H₂

and

H₂\textcircled{×}H₁

yield identical results. This most important feature of the confocal method is utilized by the phase contrast method.

In Formula 1, the spatial filter H₁ on the incident side can be producted with the complex transmission coefficient T of the sample (T′=H₁T), but in Formula 2, it acts as a Fourier filter acting upon the sample (FT[H₁]T). This makes it possible to set the phase plate in front for the sample.

FIG. 13 shows the filter functions and images that are specifically realized in the transmission phase contrast method and confocal phase contrast method. However, because the phase plate of the present invention is of a type in which the aperture stop is divided in two by a semiplanar film or fine wire, the corresponding spatial filter was taken as a one-dimensional function in the direction perpendicular to the half planar film or fine wire. Further, as described hereinabove, in the confocal method, even when the filter (H₁) on the incident side and the filter (H₂) on the outgoing side are interchanged, the same combined filter is obtained.

As a preamble for computations given by FIG. 13, it was assumed that a spatial filter inherent to a lens system due to lens aberration or defocusing (displacement of focal point) was absent, only an aperture (open filter) and a phase plate providing a cut-off frequency served as spatial filters, and a phase plate (carbon film semicircular π filter, and magnetic fine wire π filter) for a Hilbert differential contrast method and a knife edge used in the schlieren method were employed.

In FIG. 13, the results other than those relating to the confocal phase contrast microscope (three lower rows) have already been known. Further, for the simplicity a point was taken for the sample. A scattered wave produced thereby is a point diffraction, and the image produced by the square detection thereof is a point image. Because the image of the entire sample is eventually represented by the convolution of these point images, the point image is a basis of the optical system.

A filter function demonstrated by the knife edge is equal to ½ of the sum of that of the open filter and the semicircular π filter. Therefore, the point diffraction is also the sum total of the point diffractions produced by the two filters. However, the amplitude is reduced to ½ and the intensity is reduced to ¼. This is shown in the third and sixth columns in FIG. 13.

The semicircular π filter combined with an open filter provides a Foucault differential contrast method similar to that of the moving knife edge, but the intensity is twice that in the case of knife edge. With the knife edge, because half of the electron beam is completely shielded, the intensity is decreased, but with the π/2 filter, the entire electron beam is used and, therefore, the intensity is restored.

The advantages of the point images that are actually observed will be described below.

In the case of an open filter, in the transmission method, the functional form is (sinαk/αk)², and in the confocal method, it is (sinαk/αk)⁴ (α is determined by a cut-off frequency). Because the powers are different (two and four), firstly, the line width of the point image in the confocal method is narrower than that in the transmission method. Thus, the resolution is improved by a factor close to two. Secondly, the foot portion that expands, while oscillating, beyond the first zero point determined by the inverse number of the cut-off frequency is weakened in the confocal method. Therefore, the point image has good sharpness. This feature has an important meaning with respect to the below described halo problem of the phase contrast image.

For the semicircular π filter, a square of differential images is realized, but in this case, the width of the differential image of the confocal method is half that of the transmission method. Another important aspect is that the combined spatial filter of the confocal method (see Formula 2 above) becomes zero in the point of origin (see fifth column in FIG. 13). Therefore, a direct beam component that represents zero-order light, that is, bright field, is eliminated and a dark field is obtained. Thus, a differential contrast image in the dark field is realized.

The point image of the transmission method with a knife edge is composed of three components. Two of these components are identical to point images of the open filter and the semicircular π filter (the intensity is, however, ¼), but the third component is an interference term of the two. The interference term is of a differential type, as shown in the very last column of third row in FIG. 13. Therefore, a convolution of this point image and a two-dimensional function produced by the complex transmission coefficient of the sample (T or T′ in Formula 1, Formula 2) provides a differential contrast image. In the confocal method the conditions are the same as in the transmission method, but the resolution is improved. Another important aspect is that the image tail that expands beyond the first zero point (1/k₀) of the point image that is determined by the inverse number of the cut-off frequency is strongly suppressed in the confocal method, as described herein above. This is because in the combined spatial filter inherent to the confocal method, the cut-off frequency has no discontinuous jump such as in the transmission spatial filter. Such tail component is demonstrated in the image as the so-called halo of the phase contrast method. Therefore, in the confocal phase contrast method, the halo is inhibited.

As described above, the phase contrast method of the confocal method has a number of advantages over the transmission method.

viii) Optimum Combination of Phase Plate H₁ on the Incident Side and Aperture H₂ on the Outgoing Side

In the example shown in FIG. 13, the cut-off frequencies on the incident side and outgoing side were taken to be the same (corresponding to numerical aperture of the lens), but the recovery of low-frequency components is important for contrast enhancement, in particular in the case of the phase contrast method. Therefore, the effect resulting from a relative increase in the cut-off frequency of the phase plate can be considered.

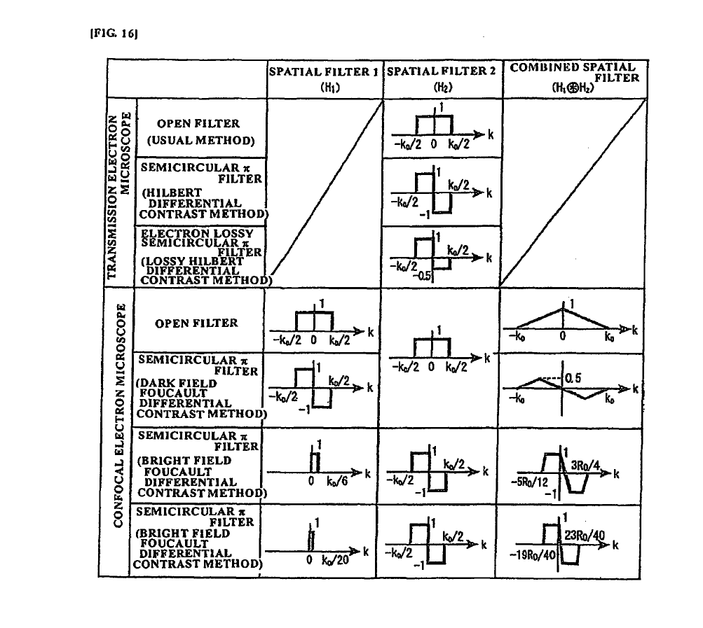

FIG. 14 shows an example in which the shape of the combined spatial filter was calculated with respect to the case in which a semicircular π filter was used. As described before, the same results are obtained even when the filter (H₁) on the incident side and the filter (H₂) on the outgoing side are interchanged.

As understood from FIG. 14, two effects are demonstrated following a relative increase in the cut-off frequency on the phase plate side. The first effect is the increase in the cut-off frequency of the combined spatial filter. Another effect is that the inclination of the straight line about k=0 as a center on the low-frequency side is increased with respect to that in the case the cut-off frequency is the same on the incident side and the outgoing side.

The image contrast is determined by the components on the low-frequency side; it means that the contrast can be expected to be increased by a relative increase in the cut-off frequency of the phase plate. FIG. 14 shows that this effect becomes stronger with the relative increase in the cut-off frequency of the phase plate. In particular, where the open filter side is made as a pinhole and the frequency ratio is made infinitely large, the so-called Hilbert differential contrast method (see second row in FIG. 13) is realized, as can be seen in FIG. 14V, and a low-frequency component is maximized.

Because the cut-off frequency of the combined spatial filter is a sum cut-off of frequencies on the incident side and outgoing side, where the cut-off frequency of the combined spatial filter has been set in advance, in other words, where the resolution of image has been set, what will be the allocation thereof on the incident side and outgoing side becomes a problem. In order to optimize the contract and resolution at the same time, the frequency on the incident side shown in FIG. 14III may be about twice that on the outgoing side, and in order to maximize only the contrast, the aperture on the outgoing side may be reduced as much as possible, for example, to about one tenth on the outgoing side.

However, if the aperture on the outgoing side is reduced, the information source that arises from scattered electrons is lost. In order to avoid this result, the we can employ a reduced aperture on the incident side and a phase plate on the outgoing side, where the light source must be made brighter to compensate the aperture reduction.

The results of the simulation test of the electron microscope will be described hereinbelow in greater details with the object of studying the specific features of the confocal phase contrast method.

ix) Performance Test of the Confocal Phase Contrast Method Using an Electron Microscope Simulator

A computer test of the confocal phase contrast method was performed using a simulator of an electron microscope that accurately reproduce electron microscopic experiments, and the performance of various combined spatial filters was compared.

A one-dimensional chain of a metal cluster (M₁₃) composed of 13 metal atoms was assumed to be a sample. FIG. 15(a) shows a M₁₃ model, and FIG. 15(b) is an arrangement of one-dimensional chain of metal clusters in which four metals: gold (Au), palladium (Pd), copper (Cu), and nickel (Ni), serve as elements components of the metal cluster. Au, Pd, etc. actually represent metal clusters such as Au₁₃, Pd₁₃.

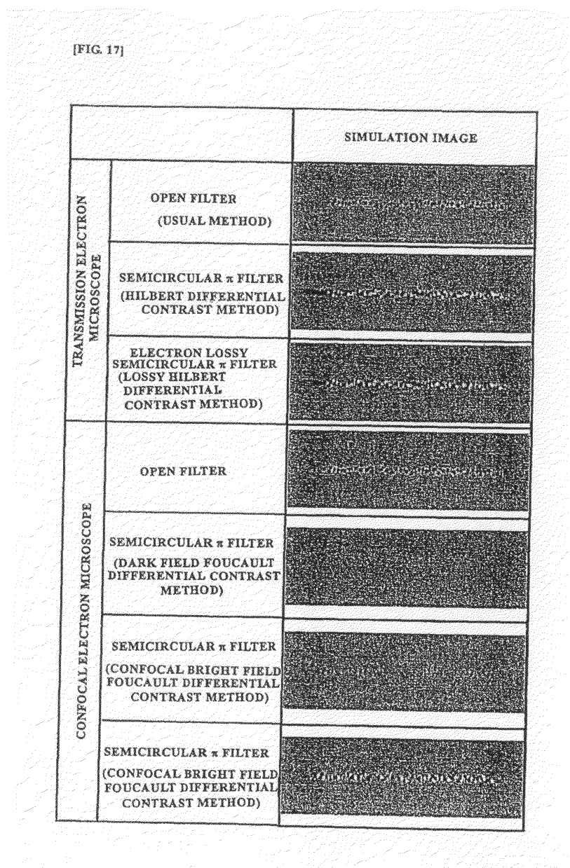

FIG. 16 shows filter conditions for the simulation and FIG. 17 shows corresponding simulated electron microscope images obtained when one-dimensional chain of metal clusters was assumed as a sample. Rows 1 to 3 in FIG. 17 are simulation images corresponding to the phase plate of the conventional transmission electron microscope, and rows 4 to 7 in FIG. 17 are simulated images for the confocal electron microscope.

In the transmission electron microscope simulation for the conventional method, the signal intensity shown in FIG. 17 is almost the same in the defocus contrast method (uppermost row, defocus=100 nm) and a loss-less (or loss-free) Hilbert differential contrast method (third row, defocus=0 nm). In the loss-less (or loss-free) Hilbert differential contrast method (second row, defocus=0 nm), the intensity is higher than in the two aforementioned cases and the advantage of the phase contrast method is clearly demonstrated.

In the confocal electron microscope simulation, when the open filters were assumed to be on the incident side and on the outgoing side (fourth stage, z=100 nm), the results obtained are practically identical to those obtained for the transmission electron microscope (uppermost row). On the other hand, in the dark field Foucault differential contrast method (fifth row) in which a semicircular π plate is inserted on the incident side, it is clear that the signal intensity is significantly weakened. This phenomenon occurs because the signal component in the vicinity of zero frequency (k=0) is inhibited to a minimum, as follows from the combined spatial filter. As a result, the advantage of the confocal method in which a filter can be disposed on the incident side was canceled by the decrease in signal intensity.

This weakness can be avoided by applying a bright field Foucault differential contrast method that restores the signal intensity in the vicinity of k=0 (see to the sixth and seventh rows). In order to restore the signal at k=0, it is possible to insert an aperture with a small cut-off frequency in either of H₂ and H₁, as seen in the sixth row and seventh row in FIG. 16, and use a semicircular π filter as another filter. In this case, the combined spatial filer can restore the signal in the vicinity of k=0, as shown in the sixth row and seventh row, by slightly shifting the open filter from the optical axis center (k=0). The degree of restoration improves with the decrease in the cut-off frequency of the aperture (seventh row).

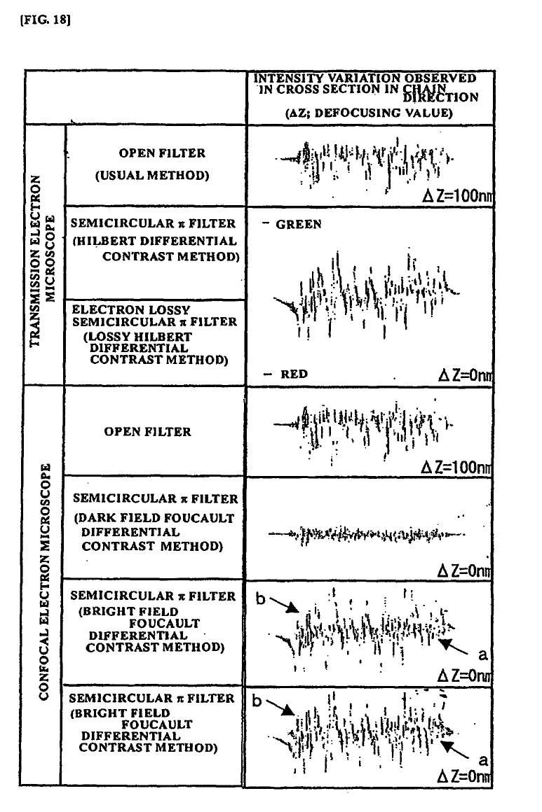

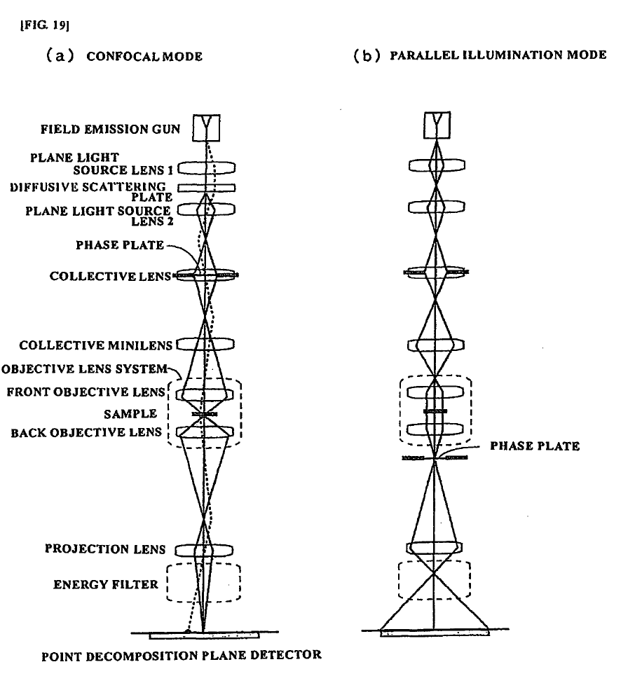

The prevention of halo that is a specific feature of the above-described differential contrast method is better understood in comparison with the transmission Hilbert differential contrast method (second row). The bright field Foucault differential contrast method and the transmission Hilbert differential contrast method are shown together by symbol a and symbol b, respectively, in the sixth row and seventh row in FIG. 18, and a long tail (halo) of the transmission Hilbert differential contrast method is completely eliminated in the bright field Foucault differential contrast method. In particular, because a small aperture with a cut-off of k₀/20 is used, the method is perfect in that there is no halo, the signal intensity being the same as that of the transmission Hilbert differential contrast method.

As described above, even when the insertion order of filters H₁, H₂ is inverted, the results obtained with the combined spatial filter are the same and the image is also the same. However, in actual image forming systems, there is always a competition between the signal intensity and noise, and the discussion cannot be based on the filter shape alone. In order not to hinder the scattered electrons that are scattered from the sample and necessary to form an image, in the bright field Foucault differential contrast method, a small aperture has to be placed on the incident side and a semicircular π filter has to be placed on the outgoing side. In the case where a narrow aperture is placed on the incident side, light is attenuated, but such attenuation can be compensated by increasing the intensity of the light source. On the other hand, where a narrow aperture is placed on the outgoing side, the lost scattered electrons that are source of information cannot be recovered.

The following is clear from the simulation shown in FIG. 16 to FIG. 18. In the confocal dark image Foucault differential contrast method in which a phase plate is introduced on the incident side, the problems associated with electric charging of the phase plate and loss can be avoided, and a perfect differential contrast image can be obtained, but the signal intensity is low. Therefore, this method is suitable for applications in material science such as metal or semiconductor where the intensity of electron beam is sufficiently high. In the bright field Foucault differential contrast method in which a phase plate is introduced on the outgoing side and a narrow aperture is introduced on the incident side, the halo is prevented and the signal is actively restored. Therefore, the method is suitable for handling biological samples that are easily damaged by electron beams and cannot withstand a large electron beam dose. However, the phase plate itself has to be improved (for example, by applying a magnetic fine wire or the like) to avoid problems associated with electric charging of the phase plate and loss.

ix) Universal-Type Confocal Electron Microscope

A universal type in which switching between the transmission method and confocal method is possible will be explained below as another specific example of the present invention. The general outline thereof is shown in FIGS. 19(a), (b).

The configuration includes a light source of a field emission gun type with good interference ability in a small-spot light source, a non-interferential plane light source generating lens system for realizing a non-scanning confocal method, a collective lens into which a phase plate holder on the incident side can be inserted, a collective minilens for switching between a transmission type and a confocal type, an objective lens in which a front magnetic field and a back magnetic field have a symmetrical design (in the confocal type, the objective lens functions as a front objective lens and back objective lens), a projection lens that creates a light source image on the light receiving plane in the confocal type and a sample image on the entire light receiving plane in the transmission type, and an energy filter inserted behind the projection lens. The optical path diagrams in FIGS. 19(a) (b) correspond to the confocal phase contrast electron microscopy and transmission phase contrast electron microscopy. This configuration also clearly demonstrates the switching therebetween.

x) Specific Features and Summary of the Present Invention

As described hereinabove, specific properties of the confocal method are practically not demonstrated in the usual electron microscope configuration, but in accordance with the present invention, the confocal phase contrast method demonstrates advantages over the transmission phase contrast method. With consideration for the confocal electron microscope that realizes these advantages, a bright field Foucault differential contrast method and a dark field Foucault differential contrast method were invented. The confocal method has the following advantages over the transmission method: (1) a higher resolution, (2) complete elimination of loss of scattered electron beam from the sample; (3) reduction of sample charging effect; (4) prevention of halo inherent to the phase method; (5) absence of image distortion caused by defocusing; and (6) capability of picking up the image at once, without scanning.

1. An electron microscope having a confocal configuration in which a collective lens and a front objective lens on the incident side and a back objective lens and a projection lens on the outgoing side are disposed symmetrically with respect to a sample as a center, the electron microscope being configured as a lens system in which a light source image is formed on the sample and an image observation surface, wherein a spatial filter such as an aperture or a phase plate that can be introduced and removed is inserted in the collective lens on the incident side, and a spatial filter such as an aperture or a phase plate that can be introduced and removed is inserted in the projection lens on the outgoing side.

2. The electron microscope according to claim 1, which is of a sample scanning type in which the light source is a point light source, a detector is a point detector, and the sample itself is scanned.

3. The electron microscope according to claim 1, which is of a light flux scanning type in which the light source is a point source, a detector is a point detector, the sample is fixed, a deflecting plate is introduced in the vicinity of a back focal point of the collective lens and in the vicinity of a front focal point of the objective lens respectively, and a conjugate scanning is performed.

4. The electron microscope according to claim 1, which is of a non-scanning type in which the light source is a non-interferential plane light source, a detector is a point decomposition plane detector such as a CCD camera, and the sample is fixed and observed.

5. The electron microscope according to claim 1, which employs a confocal method in which a semicircular π phase plate or a knife edge is inserted as the spatial filter in the collective lens on the incident side, and an aperture is inserted as the spatial filter in the projection lens on the outgoing side.

6. The electron microscope according to claim 1, which employs a confocal method in which an aperture is inserted as the spatial filter in the collective lens on the incident side, and a semicircular π phase plate or a knife edge is inserted as the spatial filter in the projection lens on the outgoing side.

7. The electron microscope according to claim 1, which employs a confocal method in which a semicircular π phase plate or a knife edge is inserted as the spatial filter in both the collective lens on the incident side and the projection lens on the outgoing side.

8. The electron microscope according to claim 1, wherein a front magnetic field of the objective lens forms the front objective lens.

9. The electron microscope according to claim 1, wherein a back magnetic field of the objective lens forms the back objective lens.

10. The electron microscope according to claim 1, having a plurality of collective lenses into which the spatial filter can be inserted.

11. The electron microscope according to claim 1, having a plurality of projection lenses into which the spatial filter can be inserted.

12. The electron microscope according to claim 1, wherein an energy filter is inserted behind the projection lens.

13. The electron microscope according to claim 1, wherein a tilting stage having a tilting function is inserted as a sample stage and tomographic image reconstruction is enabled.

14. The electron microscope according to claim 1, wherein a tilting sample stage that can be temperature controlled to a high temperature is inserted as a sample stage.

15. The electron microscope according to claim 1, wherein a tilting sample stage that is cooled with liquid nitrogen is inserted as a sample stage.

16. The electron microscope according to claim 1, wherein a tilting sample stage that is cooled with liquid helium is inserted as a sample stage.

17. The electron microscope according to claim 1, wherein a stage for performing a mechanical elongation test of the sample is inserted.

18. The electron microscope according to claim 4, wherein a plane light source in which two collective lenses are combined with a diffusive scattering plate inserted between the lenses is used as a non-interferential light source of an electron beam.

19. The electron microscope according to claim 18, wherein a thin film of a noble metal is used as the diffusive scattering plate.

20. The electron microscope according to claim 18, wherein a very small central light shielding plate is inserted as the spatial filter on the incident side and a background inelastic scattering generated from the diffusive scattering plate is caused to extinct.

21. The electron microscope according to claim 4, wherein photoelectrons from a photoelectric plate irradiated with a laser beam are used as a non-interferential light source of an electron beam.

22. The electron microscope according to claim 1, wherein a collective minilens is disposed, switching can be performed between a confocal mode and a parallel illumination mode, and a confocal electron microscope and a transmission electron microscope can be used together.

23. The electron microscope according to claim 22, wherein a filter stage for a phase plate that can be introduced into the collective lens and removed therefrom is mounted for a confocal mode, and a filter stage for phase plate that can be introduced in a back focal plane of the objective lens system and removed therefrom is mounted for a parallel illumination mode.

24. The electron microscope according to claim 5, wherein the value relationship of a cut-off frequency of the phase plate and a cut-off frequency of the aperture can be freely set to optimize a combined spatial filter composed of the phase plate on the incident side and the aperture on the outgoing side.

25. The electron microscope according to claim 6, wherein the value relationship of a cut-off frequency of the phase plate and a cut-off frequency of the aperture can be freely set to optimize a combined spatial filter composed of the aperture on the incident side and the phase plate on the outgoing side.

26. The electron microscope according to claim 7, wherein the value relationship of cut-off frequencies of the two phase plates can be freely set to optimize a combined spatial filter composed of the phase plate on the incident side and the phase plate on the outgoing side.
